(19) United States
(12) Patent Application Publication
(10) Pub. No.: US 2012/0269933 A1
(43) Pub. Date: Oct. 25, 2012

(54) FILTERING AND PERMEABLE CONTAINER FOR SUBSTANCES SUITABLE FOR THE PREPARATION OF BEVERAGES

(76) Inventor: Gino Rapparini, Bologna (IT)

(21) Appl. No.: 13/502,860

(22) PCT Filed: Oct. 19, 2010
(86) PCT No.: PCT/EP2010/006389

§ 371 Date: Jul. 12, 2012

(30) Foreign Application Priority Data
Oct. 21, 2009 (IT) BO2009A000679

(51) Int. Cl. B65D 85/00; B65B 29/02; B65D 8/08; B29C 51/00

(52) U.S. Cl. 426/82; 264/319; 220/669; 206/5; 206/459.5

(57) ABSTRACT

Filtering and permeable container for substances (6) suitable for the preparation of beverages, the container being made by means of thermoforming starting from a flat strip (1) of permeable, filtering and thermoformable material, wherein the body (2) of the container comprises longitudinal stiffening ribs (4) wherein the length of the ribs (4) is variable along the surface of the body (2). The container can be adapted to contain water-soluble products or coffee, tea, herbal tea, or similar substances adapted to obtain hot or cold beverages.

### FIELD OF THE INVENTION

The present invention relates to the field of containers for substances suitable for the preparation of beverages. In particular, the present invention relates to the field of filtering and permeable containers for substances such as water-soluble substances, coffee, tea, herbal tea or the like.

### STATE OF THE ART

Several kinds of bags or flexible pads are known in the art for obtaining beverages such as tea, herbal teas, coffee or similar beverages such as water-soluble substances based beverages.

These kinds of bags or pads are easily deformed so that the handling of same is complicated and particularly critical, especially in the case of filling and/or packaging machines working at high production rates.

In order to try to overcome these problems, capsule packages have been provided such as those described for example in EP 0 521 186 A1 and in US 2005/0051478 A1.

EP 0 521 186 A1 describes a capsule package containing roast and ground coffee for the preparation of a coffee beverage. The capsule package described in EP 0 521 186 A1 has body and membrane components. The body has a frusto conical shape with base portion capable of allowing flow of a coffee beverage therethrough, an annular sidewall portion which extends transversely from the base about a package body interior space and defines an opening which opposes the base portion, and a rim portion which extends about the opening and transversely from the sidewall portion in a direction away from the opening. The body and the membrane are made of a permeable flexible plastic material. The stability of the system described in EP 0 521 186 A1 is not optimized. In particular, the capsule packages according to EP 0 521 186 A1 are still easily deformed, especially when they are handled by filling and/or packaging machines working at very high production rates.

US 2005/0051478 A1 describes a beverage filter cartridge having an impermeable cup-shaped out container internally subdivided by a generally cup-shaped filter element into a first chamber inside the filter and a second chamber located between the filter bottom and the container bottom. The upper rim of the filter is joined at a peripheral juncture to the container side wall, and the filter side wall has exterior channels that face the container side wall and lead downwardly from the peripheral juncture to the second chamber. In particular, the channels are provided by forming the filter side wall with a fluted configuration or by pleats in the filter side wall so that the channels increase in width from a minimum at the upper rim of the filter to a maximum at the filter bottom. The channels formed in the filter sidewall according to US 2005/0051478 A1 are not provided for improving the stability of the structure of the system especially for its handling in filling and/or packaging machines working at very high production rates. Accordingly, the structure of these channels is not optimized for the purpose of improving the stability of the structure but rather for encouraging through flow in upper regions of the filter wall. The cartridges described in US 2005/0051478 A1 still exhibit therefore a low stability and render the handling procedures in packaging and/or filling machines extremely industrious, time consuming and costly.

The present invention allows overcoming the problems and drawbacks of the systems known in the prior art. In particular, the present invention guarantees stability of the structure of filtering and permeable containers so that they can easily be handled in packaging and/or filling machines even when these machines operate at very high rates. Moreover, the present invention provides containers which are easily employed in automatic machines both for domestic and industrial use.

### SUMMARY

The present invention relates to filtering and permeable containers for substances suitable for the preparation of beverages, such as water-soluble substances or coffee, tea, herbal tea or the like.

The present invention is based on the idea of providing the body of the container with longitudinal stiffening ribs wherein the length of the ribs is variable along the surface of the body. The presence of ribs having different lengths on the body of the container allows the optimization of the stability of the container. The modulation of the length of the ribs along the surface of the container allows improving the stability and rigidity of the system.

According to an embodiment of the present invention, a filtering and permeable container for substances suitable for the preparation of beverages is provided, the container being made by means of thermoforming starting from a flat strip of permeable, filtering and thermoformable material, wherein the body of the container comprises longitudinal stiffening ribs, wherein the length of the ribs is variable along the surface of the body.

According to a further embodiment of the present invention, a container is provided, wherein long and short ribs are alternated along the surface of the body. The stability of the container is accordingly optimized by providing for example long ribs extending at least partially in the bottom region of the container alternated to short ribs extending only along the side region of the container.

According to a further embodiment of the present invention, a container is provided, wherein the depth of one or more of the ribs decreases toward the bottom of the container. In particular, since one or more of the ribs have a depth which is decreasing toward the bottom of the container, the stability and handling of the container are optimized.

According to a further embodiment of the present invention, a container is provided, wherein at least along a portion of one or more of the ribs, the width of the ribs decreases toward the bottom of the container, so that said one or more of the ribs have a pointed shape. In this way the stability of the container is further optimized. In particular, the side portion of the body is stiffened by the presence of the stiffening ribs and the bottom portion is minimally altered by the presence of those ribs having a pointed shape pointing toward the bottom of the container.

According to a further embodiment of the present invention, a container is provided, wherein the stiffening ribs increase the filtering surface of the body.

According to a further embodiment of the present invention, a container is provided, further comprising an upper annular rim adapted to stiffen the structure of the body.

According to a further embodiment of the present invention, a container is provided, wherein the rim is substantially flat and has a thickness substantially corresponding to the thickness of the flat strip.

According to a further embodiment of the present invention, a container is provided, wherein the container is sealed by means of a filtering film after having been filled with a substance suitable for the preparation of beverages.

According to a further embodiment of the present invention, a container is provided, wherein the container is hermetically contained into a hermetic and impermeable capsule so as to guarantee the preservation of the organoleptic properties of the substances contained in the container.

According to a further embodiment of the present invention, a container is provided, wherein the container is adapted to be employed in automatic espresso machines. In particular, the container can be adapted to be employed for example for automatic domestic espresso machines or for industrial espresso machines.

According to a further embodiment of the present invention, a container is provided, wherein the container is adapted to be employed in moka pots. For example, the total height of the container can be adapted to insert the container in the basket of existing moka pots.

According to a further embodiment of the present invention, a container is provided, wherein the container further comprises a suspension wire comprising a label so that the container can be introduced into a pot containing boiling water, such as a tea pot or the like.

According to a further embodiment of the present invention, a container is provided, wherein the container further comprises a suspension tab, the suspension tab being adapted to support writings, signs or the like.

According to a further embodiment of the present invention, a method for the production of a filtering and permeable container for substances suitable for the preparation of beverages is provided, the container being made by means of thermoforming starting from a flat strip of permeable, filtering and thermoformable material, the method comprising the step of the formation of longitudinal stiffening ribs on the body of the container, wherein the length of the ribs is variable along the surface of the body.

According to a further embodiment of the present invention, a method for the production of a filtering and permeable container for substances suitable for the preparation of beverages is provided, wherein the formation of the body of the container is performed by means of a thermoforming punch and a matrix, the thermoforming punch comprising longitudinal ribs on its outer surface adapted to shape the longitudinal stiffening ribs of the body of the container, the matrix being adapted to house the thermoforming punch so as to form simultaneously the body and the stiffening ribs starting from the flat strip.

### BRIEF DESCRIPTION OF THE DRAWINGS

The present invention will be described with reference to the enclosed drawings wherein the same reference numbers refer to the same and/or similar parts of the system. In the drawings:

FIG. 1 schematically displays the starting phase of the thermoforming process for the formation of a container according to an embodiment of the present invention;

FIG. 2 schematically displays an operative phase of the thermoforming process for the formation of a container according to an embodiment of the present invention;

FIG. 3 schematically displays a further operative phase of the thermoforming process for the formation of a container according to an embodiment of the present invention;

FIG. 4 schematically displays a further operative phase of the thermoforming process for the formation of a container according to an embodiment of the present invention;

FIG. 5 schematically displays a further operative phase of the process for the formation of a container according to an embodiment of the present invention wherein the formed container is cut from the strip of permeable, filtering and thermoformable material;

FIG. 6 schematically displays a 3D view of the inner region of the container according to an embodiment of the present invention;

FIG. 6bis schematically displays a 3D view of the outer region of the container shown in FIG. 6;

FIG. 7 schematically displays a 3D view of the container according to an embodiment of the present invention filled with a substance suitable for the preparation of beverages;

FIG. 8 schematically displays a 3D view of the container shown in FIG. 7 sealed by means of a filtering film;

FIG. 9 schematically displays a 3D view of the upper region of a container according to an embodiment of the present invention adapted to be employed in a moka pot and sealed by means of a filtering film;

FIG. 10 schematically displays a 3D view of the bottom region of the container shown in FIG. 9;

FIG. 11 schematically displays a 3D cut of the bottom region of the container shown in FIGS. 9 and 10;

FIG. 12 schematically displays a 3D exploded view of a moka pot employing a container according to an embodiment of the present invention;

FIG. 13 schematically displays a vertical cross section of a moka pot employing a container according to an embodiment of the present invention;

FIG. 14 schematically displays a 3D view of a hermetic and impermeable capsule containing the container according to an embodiment of the present invention;

FIG. 15 schematically displays a 3D view of a cut of the hermetic and impermeable capsule shown in FIG. 14;

FIG. 16 schematically displays a container comprising a suspension wire according to an embodiment of the present invention;

FIG. 17 schematically displays a container comprising a suspension tab according to an embodiment of the present invention.

### DETAILED DESCRIPTION

In the following, the present invention is described with reference to particular embodiments as shown in the enclosed drawings. Nevertheless, the present invention is not limited to the particular embodiments described in the following detailed description and shown in the figures, but, instead, the embodiments described simply exemplify several aspects of the present invention, the scope of which is defined by the appended claims.

Further modifications and variations of the present invention will be clear for the person skilled in the art. Therefore, the present description has to be considered as including all the modifications and/or variations of the present invention, the scope of which is defined by the appended claims.

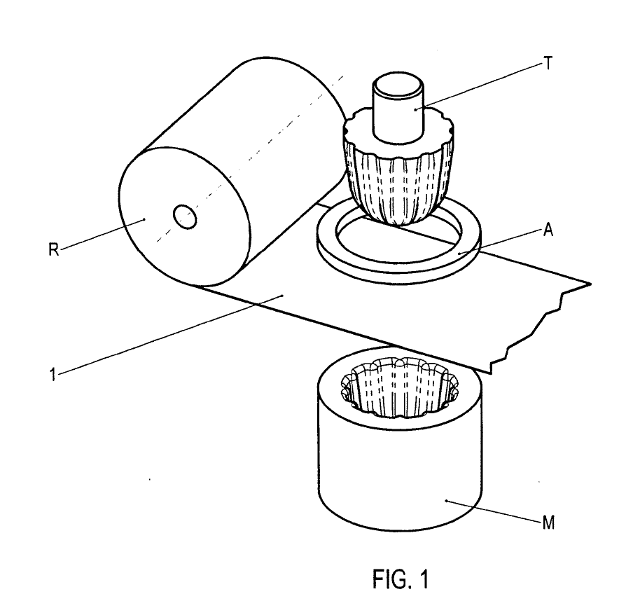

FIG. 1 schematically displays the starting phase of the thermoforming process for the formation of a container according to an embodiment of the present invention. The figure displays a reel R of permeable, filtering and thermoformable material. A flat strip 1 of this material is unwound from the roll R. The system for forming the container comprises a thermoforming punch T, a stabilizing ring A and a matrix M.

The outer surface of the apex portion of the punch T comprises ribs adapted to form ribs in the body of the container as described in detail below. The matrix M is adapted to house the punch T. In particular, as can be seen in FIG. 1, the matrix M comprises an inner cavity with a lateral surface provided with grooves adapted to engage the ribs of the apex portion of the punch T.

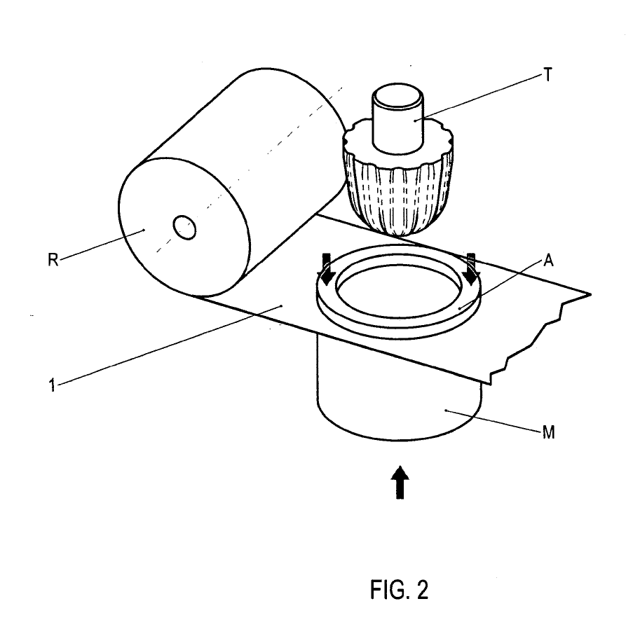

As can be seen in FIG. 2, the stabilizing ring A is employed to press the strip 1 against the upper portion of the matrix M. Accordingly, by means of the stabilizing ring A, the strip 1 is safely kept in place for the formation of the container.

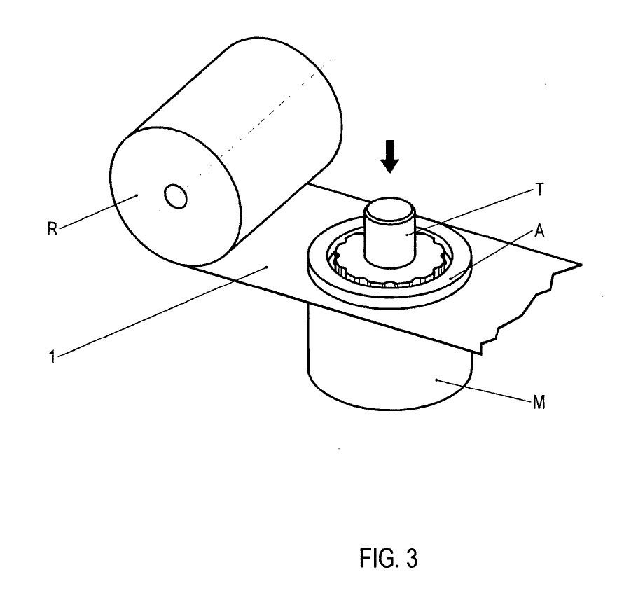

In FIG. 3, the punch T is lowered through the ring A into the matrix M so as to insert a portion of the strip 1 into the matrix M. The action of the thermoforming punch T in cooperation with the matrix M allows the formation of the body 2 of the container. In other words, both the bottom and the side portion of the container are simultaneously formed in this step. Moreover, since the punch T is provided with ribs and the matrix M is provided with corresponding grooves adapted to engage the ribs of the punch T, the body 2 is formed with stiffening ribs 4 with the optimized stiffening structure as described below. In particular, the body 2 and the stiffening ribs 4 are formed simultaneously.

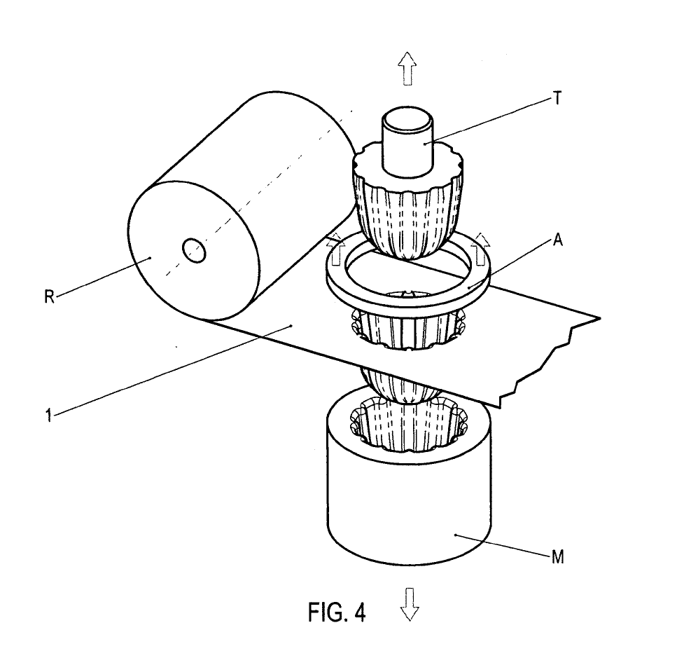

FIG. 4 displays the situation of the system when the punch T and the ring A are lifted. As can be seen, the body 2 of the container is formed with stiffening ribs 4 due to the combined action of the matrix M and of the punch T. Moreover, the region of the strip 1 located below the stabilizing ring A is not deformed. In particular, the portion of the strip 1 located below the stabilizing ring A is substantially flat and has substantially the same thickness as the strip 1.

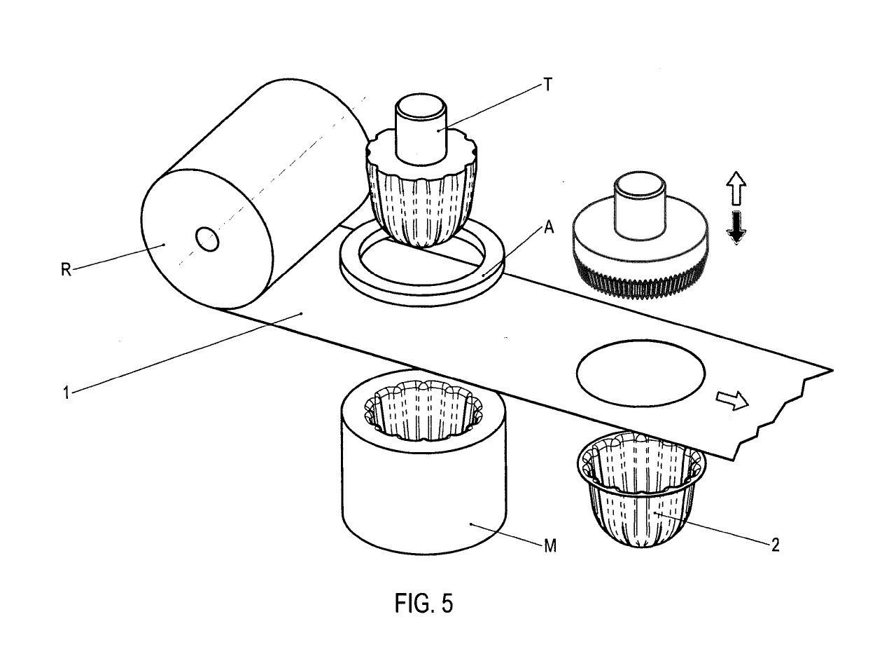

FIG. 5 schematically displays a further operative phase of the process for the formation of the container wherein the formed body 2 is cut from the strip 1 of permeable, filtering and thermoformable material. In particular, a cutting tool is employed to detach the formed body 2 from the strip 1. By means of the cutting tool, in particular by properly choosing the diameter of the cutting tool or by selecting an appropriate line of cutting, the container is provided with an upper annular rim 3. Since the upper annular rim 3 corresponds to the region of the strip below the stabilizing ring A, the annular rim 3 is substantially flat and has a thickness substantially corresponding to the thickness of the strip 1.

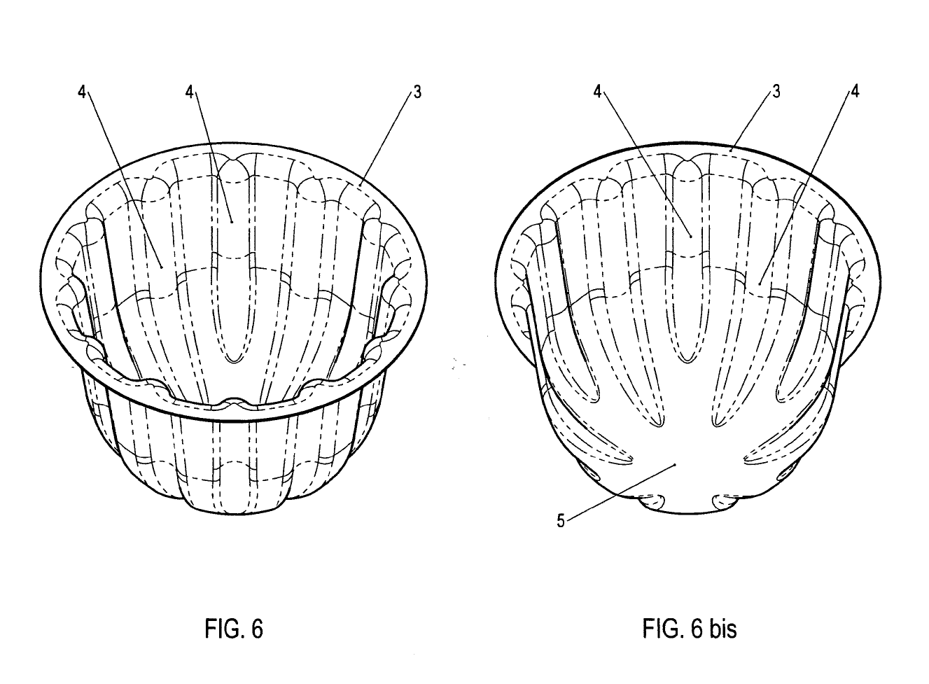

FIGS. 6 and 6bis schematically display 3D views of the container according to an embodiment of the present invention. The container is provided with longitudinal stiffening ribs 4, and the length L of the stiffening ribs 4 is variable along the surface of the body 2 of the container. In particular, long and short ribs are alternated along the surface of the body 2. The long ribs extends toward the bottom region 5 of the container. In particular, the long ribs occupy a portion of the bottom region 5 of the container. The container has a cup-shaped bottom region 5. The long stiffening ribs occupy, therefore, a portion of the cup-shaped bottom region 5. Each short rib is placed between two long ribs and extends along the lateral region of the container. Accordingly, the stabilization of the structure is optimized and, at the same time, the filtering surface of the container is increased.

Further, as can be seen in FIGS. 6 and 6bis, both the long and short stiffening ribs 4 have a depth which decreases toward the bottom of the container. In particular, the ribs 4 have maximum depth in correspondence to the upper annular rim 3 and minimum depth at their opposed end, i.e. toward the bottom region 5 of the container. This allows improving the stability of the container and, at the same time, increasing the filtering surface of the system. The varying depth of the ribs 4 allows to integrate them in the structure of the container so as to penetrate even in the bottom region of the container. In particular, since toward the bottom of the container the depth of the ribs 4 is minimal, the bottom region can be easily provided with the ribs 4.

Moreover, as can be seen in FIGS. 6 and 6bis, the width of the ribs decreases toward the bottom 5 of the container so that the ribs 4 have a pointed shape. In particular, the pointed end of the ribs 4 points toward the bottom region 5 of the container. This allows inserting a large number of stiffening ribs 4 even if the container is cup-shaped as shown in FIGS. 6 and 6bis. In particular, even the narrow bottom region 5 of the cup shaped container can be provided with ribs 4 because the width of the ribs 4 is reduced in this region with respect to the width of the ribs 4 in their upper portion.

As can be further seen in FIGS. 6 and 6bis, the container is provided with an upper annular rim 3 adapted to further stiffen the structure of the body of the container. The annular rim 3 is substantially flat and has substantially the same thickness as the flat strip 1 of permeable, filtering and thermoformable material.

The annular rim 3 and the stiffening ribs 4 guarantee the rigidity of the body 2 of the container so that it can be easily and quickly handled even at very high automated filling and/or production speeds.

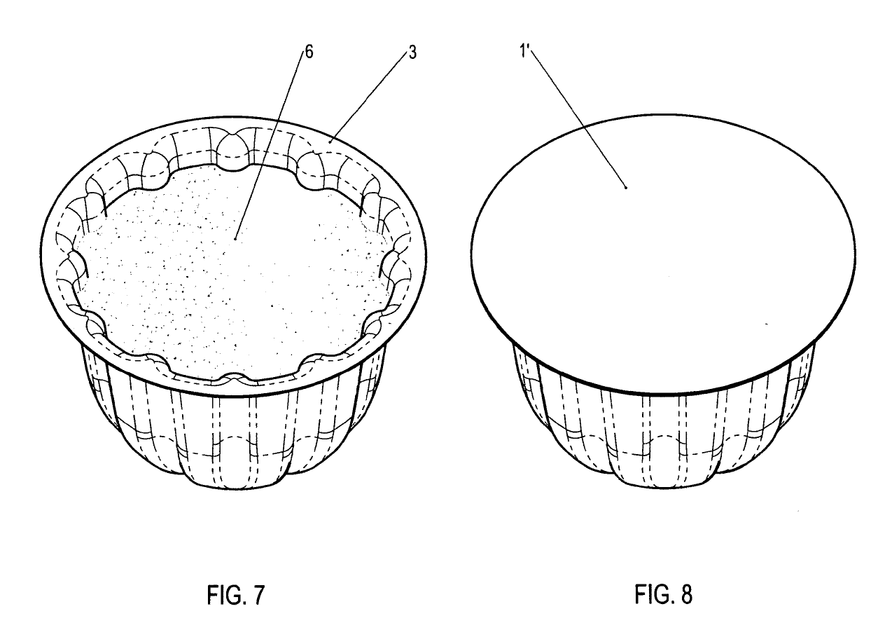

FIG. 7 schematically displays a 3D view of the container according to an embodiment of the present invention filled with a substance suitable for the preparation of beverages. The substance can be suitable for the preparation of hot or cold beverages. Examples of such substances are water-soluble substances such as milk powder or tea powder for ice tea. Further examples of such substances are infusion substances such as tea or herbal tea. Further examples of such substances are granular substances such as ground coffee or the like.

FIG. 8 schematically displays a 3D view of the container shown in FIG. 7 sealed by means of a filtering film 1′. The filtering film 1′ is permeable. Moreover, the filtering film 1′ is sealed to the upper annular rim 3 of the container.

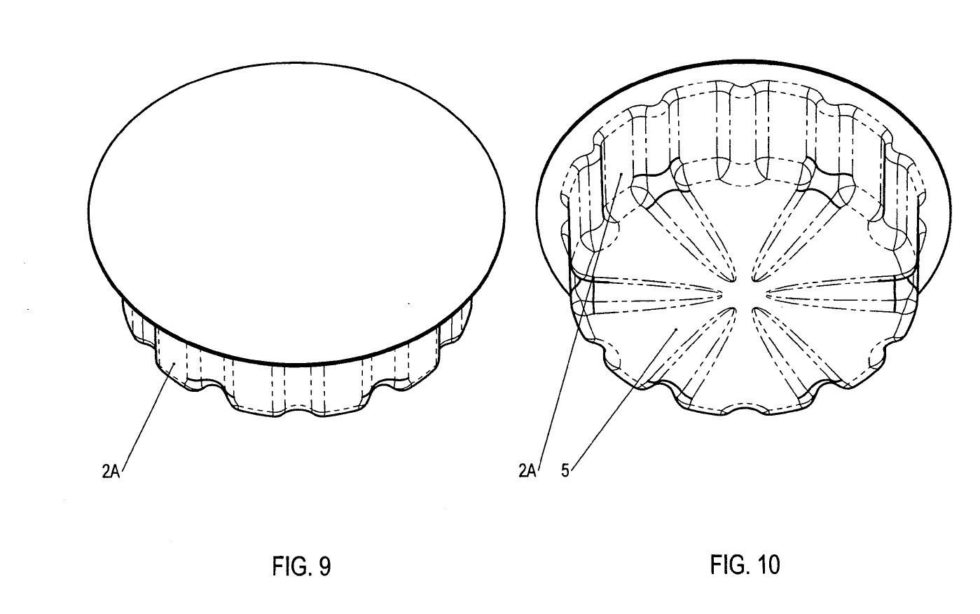

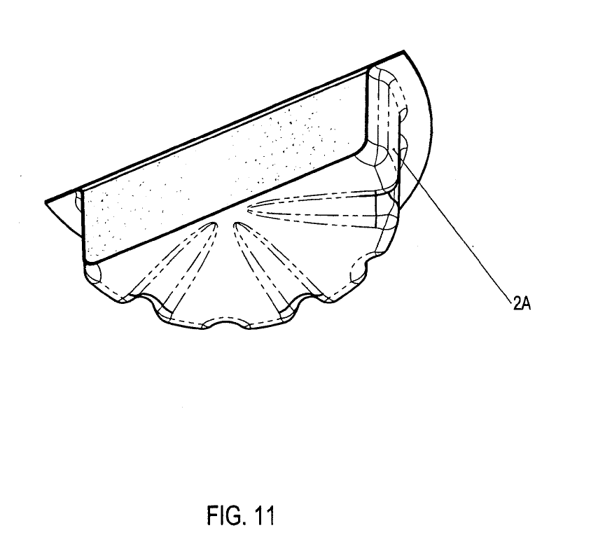

FIG. 9 schematically displays a 3D view of the upper region of a container 2A according to an embodiment of the present invention adapted to be employed in a moka pot and sealed by means of a filtering film. FIG. 10 schematically displays a 3D view of the bottom region of the container 2A shown in FIG. 9. FIG. 11 schematically displays a 3D cut of the bottom region of the container shown in FIG. 9.

The height of the container shown in FIGS. 9, 10 and 11 is lower than the height of the container shown in FIGS. 6 and 6bis. In particular, the height of the container shown in FIGS. 9, 10 and 11 is adapted to employ the container in the basket of existing moka pots.

As can be seen in FIG. 10, the alternate length of the stiffening ribs 4 is particularly advantageous in the present case. In particular, in the present case, the container 2A has substantially a cylindrical shape with a substantially flat bottom. The short ribs run only along the side wall of the container 2A. In particular, the short ribs run along the entire height of the side wall of the container 2A. The long ribs extend beyond the side wall of the container 2A in the bottom portion of same so as to meet substantially at the centre of the bottom portion of the container 2A. In particular, the pointed endings of the long ribs point toward the centre of the bottom portion of the container 2A. Moreover, the depth of the long ribs decreases toward the centre of the bottom 5 of the container 2A so as to maintain the stability of the central portion. The short ribs have substantially constant depth along their entire length. Moreover, the short ribs have substantially constant width along their entire length and do not exhibit pointed endings.

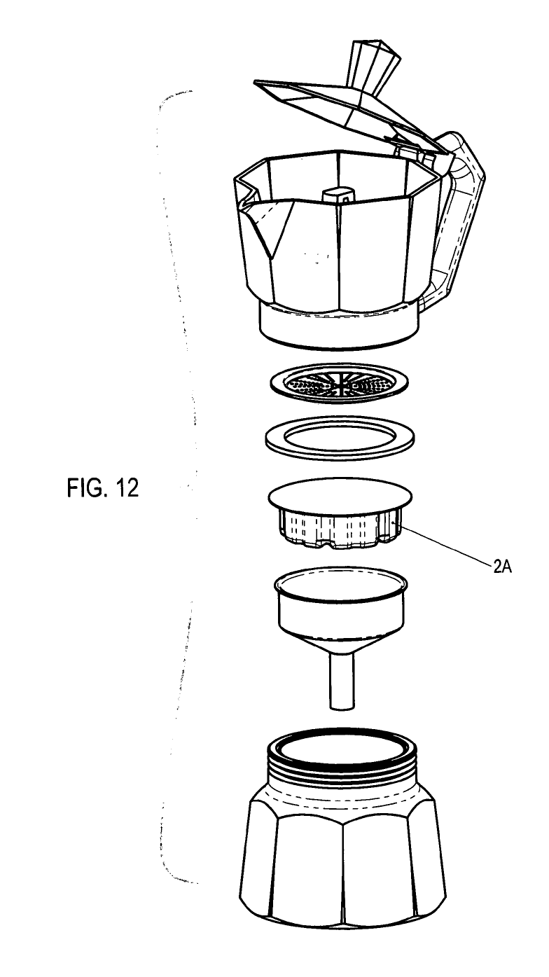

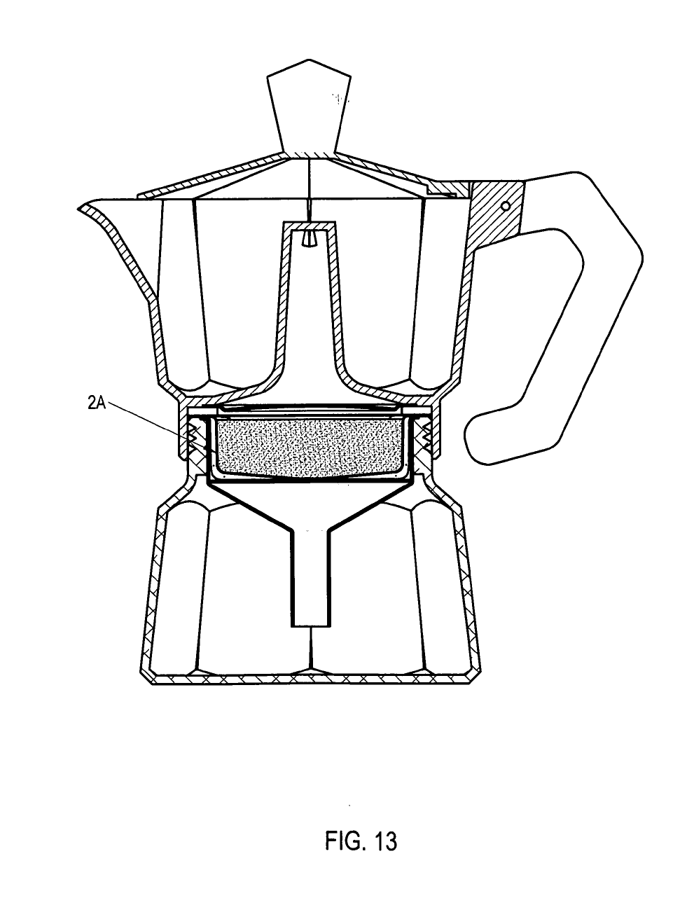

FIG. 12 schematically displays a 3D exploded view of a moka pot employing a container 2A according to an embodiment of the present invention, and FIG. 13 schematically displays a vertical cross section of the system. As can be seen in the figures, the container 2A is fitted into the basket of the moka pot. Moreover, the moka pot is a traditional existing moka pot, and no modifications are necessary for employing the container 2A according to an embodiment of the present invention.

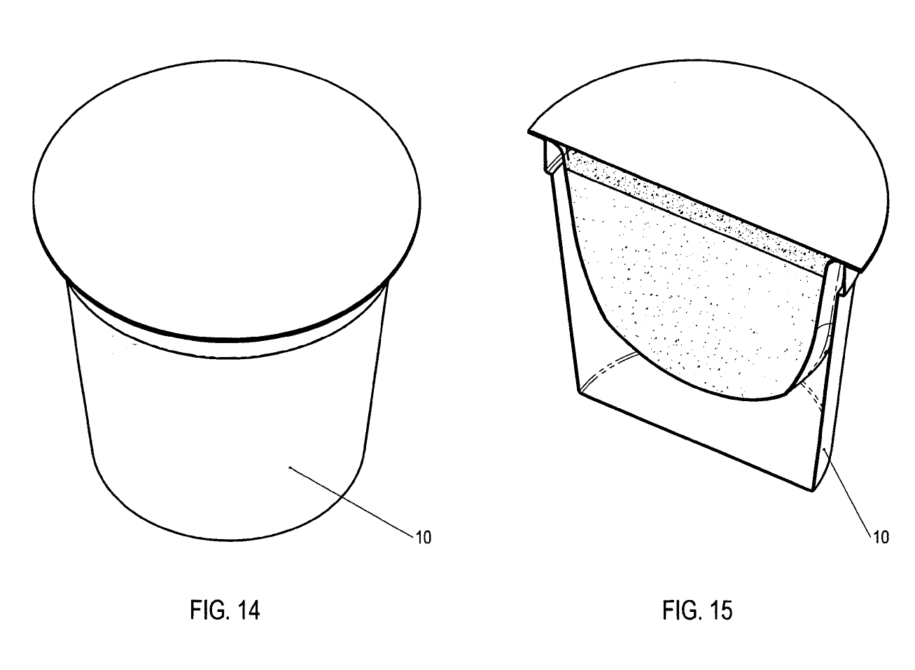

FIG. 14 schematically displays a 3D view of a hermetic and impermeable capsule 10 containing the container according to an embodiment of the present invention. FIG. 15 schematically displays a 3D view of a cut of the system shown in FIG. 14. The container is hermetically contained into the hermetic and impermeable capsule 10 so as to guarantee the preservation of the organoleptic properties of the substances 6 contained in the container.

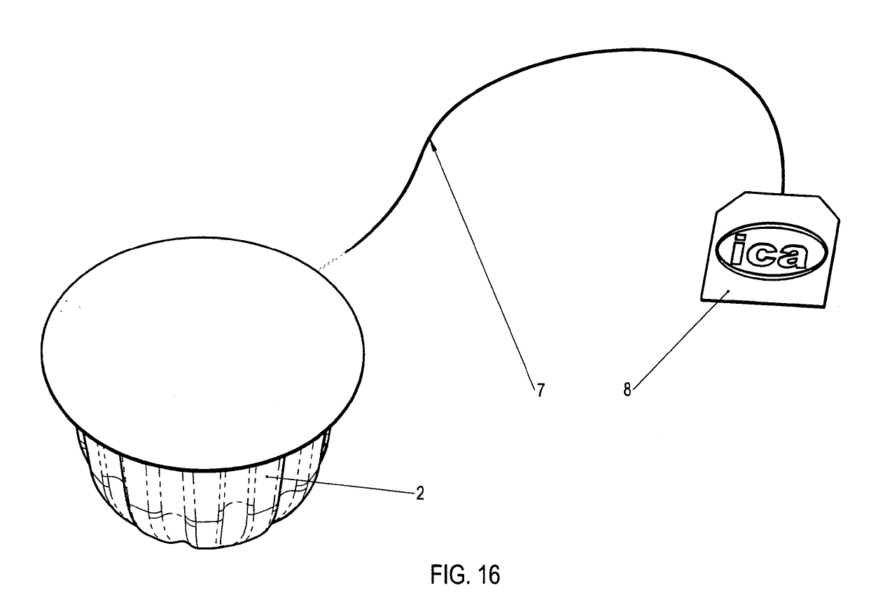

FIG. 16 schematically displays a container 2 comprising a suspension wire 7 according to an embodiment of the present invention. The suspension wire 7 is provided with a label 8. Accordingly, the container according to this embodiment of the present invention can be employed in a similar way to common tea bags. In particular, the container 2 can be easily inserted into pots containing boiling water, such as tea pots or the like. According to the present invention, also the container 2A having reduced height and substantially cylindrical shape can be provided with a suspension wire.

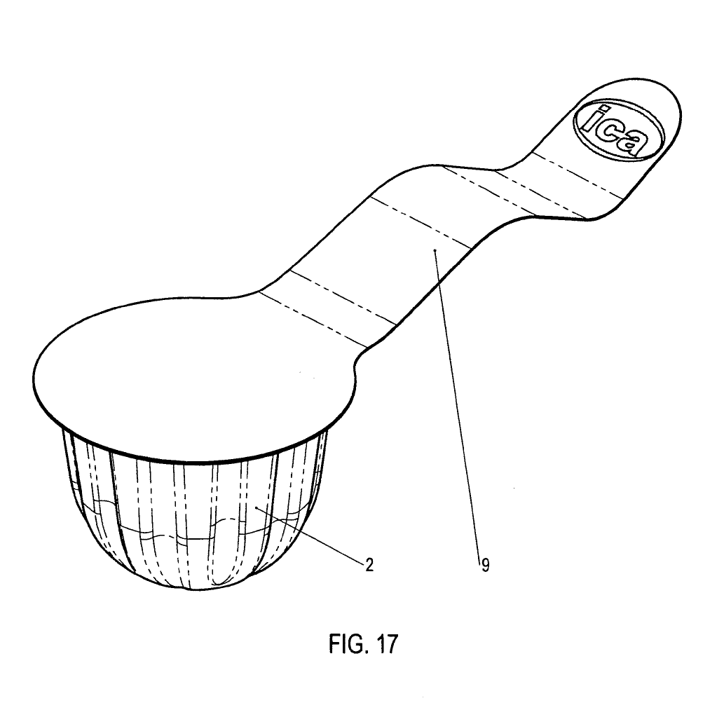

FIG. 17 schematically displays a container 2 comprising a suspension tab 9 according to an embodiment of the present invention. The suspension tab 9 is adapted to support writings, signs or the like. The suspension tab 9 is formed as an extension of the filtering film 1′ sealing the container 2. According to the present invention, also the container 2A having reduced height and substantially cylindrical shape can be provided with a suspension tab.

While the invention has been described with respect to the preferred physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

For instance, several kinds of materials can be employed for realizing the containers according to the present invention. Moreover, the containers according to the present invention can have several dimensions. For example, the containers can be adapted to be employed for domestic machines such as moka pots or automatic espresso machines. Alternatively, the containers can be adapted to be employed for industrial machines.

In addition, those areas in which it is believed that those of ordinary skill in the art are familiar have not been described herein in order not to unnecessarily obscure the invention described. Accordingly, it has to be understood that the invention is not to be limited by the specific illustrative embodiments, but only by the scope of the appended claims.

1. Filtering and permeable container for substances suitable for the preparation of beverages, comprising:
a body having a surface and a bottom;
longitudinal stiffening ribs, wherein the length of said ribs is varied along the surface of said body.

2. Container according to claim 1, wherein said longitudinal stiffening ribs comprise alternating long and short ribs along the surface of said body.

3. Container according to claim 1, wherein the depth of one or more of said ribs decreases toward the bottom of said body.

4. Container according to claim 1, wherein at least along a portion of one or more of said ribs, the width of said ribs decreases toward the bottom of said body, so that said one or more of said ribs have a pointed shape.

5. Container according to claim 1, wherein said stiffening ribs have a depth whereby the filtering surface of said body is increased.

6. Container according to claim 1, further comprising an upper annular rim whereby said body is stiffened.

7. Container according to claim 6, wherein said rim is substantially flat and has a thickness substantially corresponding to the thickness of a flat strip from which the container is formed.

8. Container according to claim 1, wherein said container is sealed by a filtering film after having been filled with a substance suitable for the preparation of beverages.

9. Container according to claim 1, wherein said container is hermetically contained into a hermetic and impermeable capsule so as to guarantee the preservation of the organoleptic properties of the substances contained in said container.

10. Container according to claim 1, wherein said container is employed in automatic espresso machines.

11. Container according to claim 1, wherein said container is employed in moka pots.

12. Container according claim 1, wherein said container further comprises a suspension wire comprising a label so that said container can be introduced into a pot containing boiling water, such as a tea pot or the like.

13. Container according claim 1, wherein said container further comprises a suspension tab, said suspension tab supporting writings or signs.

14. Method for the production of a filtering and permeable container for substances suitable for the preparation of beverages, said container having a body being made by means of thermoforming starting from a flat strip of permeable, filtering and thermoformable material, said method comprising the following steps:
formation of longitudinal stiffening ribs on the body of said container, wherein the length of said ribs is varied along the surface of said body.

15. Method according to claim 14, wherein the formation of the body of said container is performed by means of a thermoforming punch and a matrix, said thermoforming punch comprising longitudinal ribs on its outer surface adapted to shape said longitudinal stiffening ribs, said matrix being adapted to house said thermoforming punch so as to form simultaneously said body and said stiffening ribs starting from said flat strip.

16. A container for substances used in the preparation of beverages comprising:
a body having an annular rim and a cup-shaped bottom made from a permeable, filtering and thermoformable material; and
a plurality of varied length ribs having a depth extending from the annular rim towards the cup-shaped bottom,
whereby the contain has increased stability.

17. A container for substances used in the preparation of beverages as in claim 16 wherein:
said plurality of varied length ribs alternate between a short rib and a long rib.

18. A container for substances used in the preparation of beverages as in claim 17 wherein:
the short ribs extend to the cup-shaped bottom; and
the long ribs occupy a portion of the cup-shaped bottom.
